(19) United States
(12) Patent Application Publication
(10) Pub. No.: US 2016/0033167 A1
(43) Pub. Date: Feb. 4, 2016

(54) FRANGIBLE DAM FOR A WATER HEATER

(71) Applicant: General Electric Company, Schenectady, NY (US)

(72) Inventor: Timothy David Gantt, Goshen, KY (US)

(21) Appl. No.: 14/450,322

(22) Filed: Aug. 4, 2014

(51) Int. Cl. F24H 9/02; B23P 19/04

(52) U.S. Cl. CPC F24H 9/02; B23P 19/04

(57) ABSTRACT

A dam assembly for positioning around a fitting in a water heater defines an axial direction and includes a hollow extension. The hollow extension extends along the axial direction and includes a body portion positioned at a first end, a frangible section positioned at a second end, and a detachment band extending along the axial direction between the body portion and the frangible section. The frangible section is configured to be removed from the body portion along the detachment band to reduce an effective length of the hollow extension and allow the dam assembly to be used in various locations in a single water heater appliance and/or in various size water heater appliances.

### FIELD OF THE INVENTION

The present subject matter relates generally to water heater appliances, and more particularly to a dam for positioning around a fitting of a water heater.

### BACKGROUND OF THE INVENTION

Water heater appliances are utilized to heat water for a variety of purposes. In many cases, water heater appliances include a tank. Heating elements, such as gas burners, electric resistance elements, or induction elements, heat water within the tank during operation of such water heater appliances. In particular, the heating elements generally heat water within the tank to a predetermined temperature. The predetermined temperature is generally selected such that heated water within the tank is suitable for showering, washing hands, etc.

Water heater appliances generally include one or more fittings extending from the tank for, e.g., providing a flow of water to and from the tank. For example, the fittings may provide for a flow of water from a water source to the tank, or provide for a flow of heated water from the tank for use in a household or other structure.

Many water heater appliances further include a casing that generally surrounds the tank. The casing can serve to facilitate insulation of the tank (by encasing insulation material, such as foam insulation, that surrounds the tank) and can further serve to protect the tank. The tank may be provided within the interior of the casing and the fittings may extend from the tank through respective openings in the casing.

During manufacture of the water heater, a dam or seal is generally provided around one or more of the fittings between the tank and the casing. The dam may prevent a portion of insulation from escaping through an opening in the casing proximate to the one or more fittings. Different dam sizes are generally manufactured to accommodate the various depths between the tank and the casing of an individual water heater appliance and between variously sized water heater appliances. However, certain problems may exist with such a process. For example, with such a process, a variety of different dams are therefore required to be manufactured in order to assemble or manufacture one or more water heater appliances.

Accordingly, a dam assembly that may accommodate various depths of a tank and casing in a water heater appliance would be useful.

### BRIEF DESCRIPTION OF THE INVENTION

Aspects and advantages of the invention are set forth below in the following description, or may be obvious from the description, or may be learned through practice of the invention.

In one exemplary embodiment of the present disclosure, a dam assembly is provided defining an axial direction for positioning around a fitting in a water heater. The exemplary dam assembly includes a hollow extension extending along the axial direction and defining a first end, a second end, and an effective length. The hollow extension includes a body portion positioned at the first end, a frangible section positioned at the second end, and a detachment band extending along the axial direction between the body portion and the frangible section. The frangible section is configured for removal from the body portion along the detachment band. Removal of the frangible section from the body portion reduces the effective length of the hollow extension.

In an exemplary aspect of the present disclosure, a method is provided for manufacturing a water heater including a tank with a casing positioned around at least a portion of the tank. The method includes determining a first distance between the casing and the tank proximate to a fitting extending from the tank through a respective hole in the casing. Additionally, the method includes comparing the first distance to an effective length of a hollow extension of a dam assembly. Further, the method includes removing a frangible section from an axial end of the hollow extension along an axially extending detachment band such that the effective length of the hollow extension is approximately equal to the first distance. Moreover, the method includes positioning the dam assembly around the fitting between the tank and the casing.

In another exemplary embodiment of the present disclosure, a water heater is provided, the water heater including a tank for holding a quantity of water, a casing positioned around at least a portion of the tank, and a fitting extending from the tank through a respective opening in the casing. The water heater further includes a dam assembly comprising a hollow extension positioned around the fitting between the tank and the casing. The dam assembly defines an axial direction with the hollow extension extending along the axial direction. The hollow extension includes a body portion positioned at a first end of the hollow extension, a frangible section positioned at a second end of the hollow extension, and a detachment band extending along the axial direction between the body portion and the frangible section. The frangible section is configured for removal from the body portion along the detachment band to reduce an effective length of the hollow extension.

These and other features, aspects and advantages of the present disclosure will become better understood with reference to the following description and appended claims. The accompanying drawings, which are incorporated in and constitute a part of this specification, illustrate embodiments of the disclosure and, together with the description, serve to explain the principles of the disclosure.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 provides a perspective view of a water heater appliance in accordance with one embodiment of the present disclosure.

FIG. 2 provides a side cross-sectional view of a portion of the exemplary water heater appliance of FIG. 1.

FIG. 3 provides a perspective view of a dam assembly in accordance with one exemplary embodiment of the present disclosure.

FIG. 4 provides a cross-sectional view of the exemplary dam assembly of FIG. 3 with a frangible section.

FIG. 5 provides a cross-sectional view of the exemplary dam assembly of FIG. 3 with the frangible section removed.

FIG. 6 provides a cross-sectional view of a dam assembly in accordance with another exemplary embodiment of the present disclosure.

FIG. 7 provides a flow diagram of an exemplary method for manufacturing a water heater appliance.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

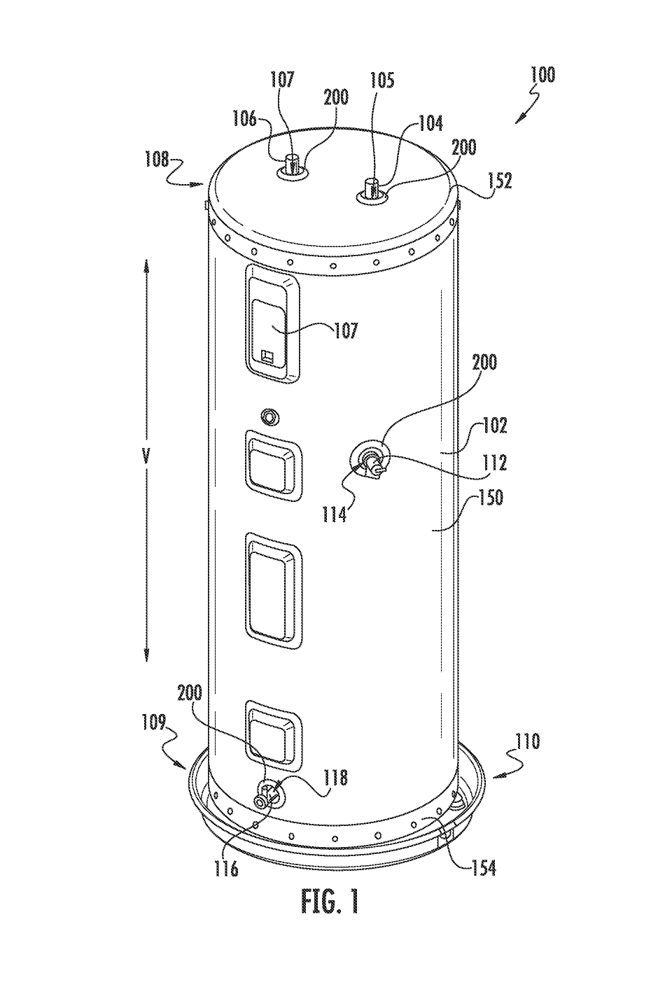

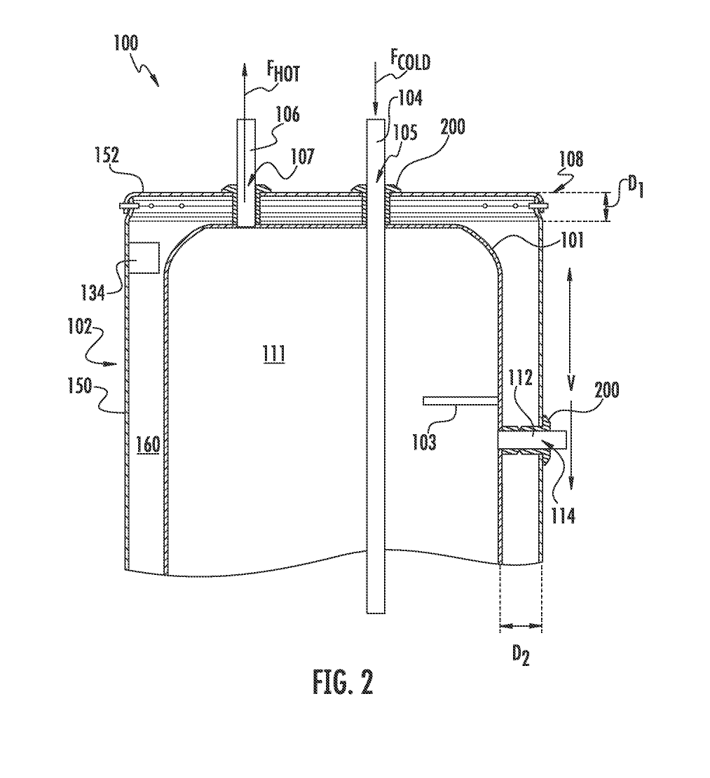

Referring now to the drawings, FIG. 1 provides a perspective view of an exemplary water heater appliance 100 and to FIG. 2 provides a side cross-sectional view of a portion of the exemplary water heater appliance 100 of FIG. 1. The water heater appliance 100 includes a tank 101 (FIG. 2) and a casing 102 and extends longitudinally between a top portion 108 and a bottom portion 109 along a vertical direction V. Thus, water heater appliance 100 is generally vertically oriented. Water heater appliance 100 can be leveled, e.g., such that the casing 102 is plumb in the vertical direction V, in order to facilitate proper operation of water heater appliance 100. A drain pan 110 is positioned at the bottom portion 109 of the water heater appliance 100 such that the water heater appliance 100 sits on the drain pan 110. The drain pan 110 sits beneath the water heater appliance 100 along the vertical direction V, e.g., to collect any water that may leak from the water heater appliance 100 or water that may condense on an evaporator (not shown) of the water heater appliance 100. It should be appreciated, however, that although the water heater appliance 100 is generally depicted as a vertically oriented water heater, in other embodiments, the water heater appliance 100 may not be vertically oriented, and instead may be, e.g., a horizontally oriented water heater appliance.

The casing 102 is positioned around at least a portion of the tank 101 (FIG. 2), and may be formed from a variety of components. For example, the exemplary casing 102 of FIG. 1 includes a wrapper 150, a top cover 152, and a bottom cover 154. The covers may be coupled to the wrapper 150 to form the casing 102.

Positioned within the casing 102 are heating elements 103 (FIG. 2) for heating water therein. The heating elements 103 may include a gas burner, a heat pump, an electric resistance element, a microwave element, an induction element, or any other suitable heating element or combination thereof. For the embodiment depicted, the heating elements 103 are positioned within the tank 101 for directly heating the water therein. However, it should be appreciated that in other exemplary embodiments, the heating elements 103 may be positioned at any other suitable location within the casing 102 or the tank 101. It should also be appreciated that as used herein, the term “water” includes purified water and solutions or mixtures containing water and, e.g., elements (such as calcium, chlorine, and fluorine), salts, bacteria, nitrates, organics, and other chemical compounds or substances.

The water heater appliance 100 also includes a plurality of fittings extending from the tank 101 through respective openings in the casing 102. For example, the water heater appliance 100 includes a cold water fitting 104 and a hot water fitting 106 that are both in fluid communication with a chamber 111 defined by the tank 101 (FIG. 2). The cold water fitting 104 extends from the tank 101 through an opening 105 in the casing 102 and the hot water fitting 106 similarly extends from the tank 101 through an opening 107 in the casing 102. During operation of the water heater appliance 100, cold water from a water source, e.g., a municipal water supply or a well, may enter the water heater appliance 100 through the cold water fitting 104 (shown schematically with arrow labeled F_{COLD} in FIG. 2). From the cold water fitting 104, such cold water may enter the chamber 111 of the tank 101 wherein it may be heated with heating elements 103 to generate heated water. Such heated water may exit the water heater appliance 100 through the hot water fitting 106 (shown schematically with arrow labeled F_{HOT} in FIG. 2) and, e.g., be supplied to a bath, shower, sink, or any other suitable feature.

The water heater appliance 100 additionally includes a pressure relief valve fitting 112 and a drain valve fitting 116, each also in fluid communication with the chamber 111 of the tank 101. The pressure relieve valve fitting 112 extends from the tank 101 through an opening 114 in the casing 102 and may provide a fluid path for the contents of the chamber 111 of the tank 101 in the event a pressure in the chamber 111 exceeds a predetermined threshold. Similarly, the drain valve fitting 116 extends through an opening 118 in the casing 102 and may provide a means for draining the water in the camber 111 of the tank 101, during, e.g., transportation or maintenance of the water heater appliance 100.

It should be appreciated, however, that the fittings provided in the embodiment depicted in FIGS. 1 and 2 are by way of example only. In other exemplary embodiments, the appliance 100 may include any other suitable number or configuration of fittings. For example, in other exemplary embodiments, the pressure relief valve fitting 112 may alternatively be positioned proximate to the bottom portion 109 of the water heater appliance 100 adjacent to the drain valve fitting 116.

The tank 101 and the casing 102 at least partially define an interior 160 therebetween. In certain embodiments, the interior 160 may include an insulating layer (not shown) disposed between the casing 102 and the tank 101. The insulating layer may be a foam, such as a spray foam insulation, provided in the interior 160 during manufacture of the water heater appliance 100. In other exemplary embodiments, the water heater appliance 100 may additionally, or alternatively, include one or more sealing layers in the interior 160 or any other suitable material.

With continued reference to FIGS. 1 and 2, positioned around each of the fittings is a dam assembly 200. The dam assemblies 200 depicted extend around a respective fitting from a surface of the tank 101 to the casing 102, or more particularly, through a respective opening in the casing 102. The dam assemblies 200 depicted provide a seal between the tank 101 and the casing 102 around a respective fitting, such as the fittings 104, 106, 112, 116 depicted in FIGS. 1 and 2. The dam assemblies 200 may therefore allow for the providing of, e.g., spray foam insulation to the interior 160 without such spray foam insulation extending through the openings proximate to the respective fittings.

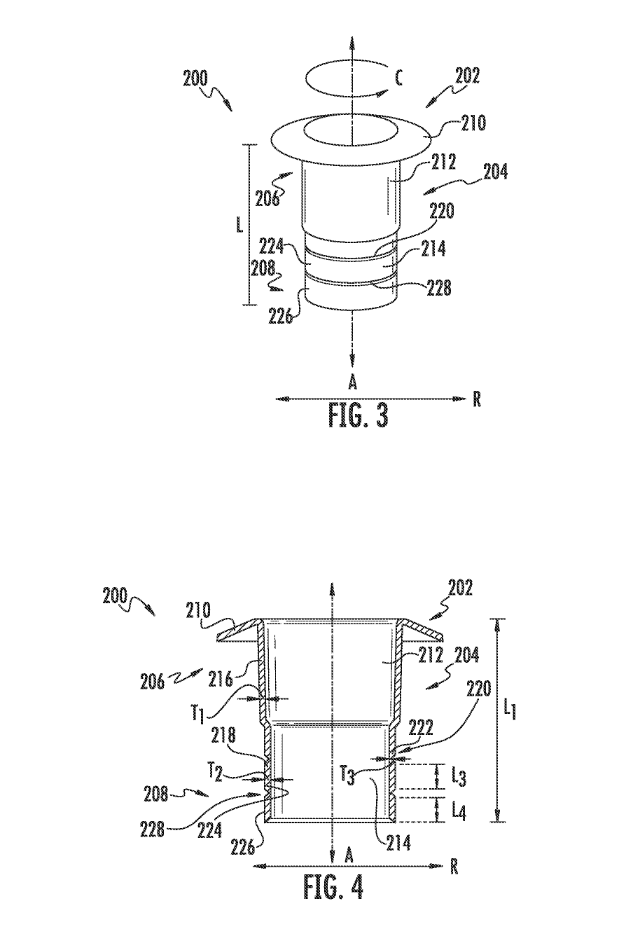

As will be explained in greater detail below, with reference to FIGS. 3 through 5, the dam assemblies 200 are configured to be adjustable, such that an effective length of the dam assembly 200 may be matched to a depth between the tank 101 and the casing 102 proximate to the fitting. For example, referring specifically to FIG. 2, the water heater appliance 100 defines a depth D₁ between the casing 102 and the tank 101 at the top end 108 of the water heater appliance 100. The water heater appliance 100 additionally defines a depth D₂ between the casing 102 and the tank 101 on a side of the appliance 100, e.g., between the wrapper 150 and the tank 101. For the embodiment of FIGS. 1 and 2, the depth D₂ is greater than the depth D₁.

The dam assembly 200 described herein may define an effective length adjustable from the depth D₂ to the depth D₁. Such a dam assembly 200 may therefore be used to provide a seal around a fitting in the water heater appliance 100 positioned at a side of the water heater appliance 100 (e.g., fittings 112, 116) or at the top end 108 of the water heater appliance 100 (e.g., fittings 104, 106). Additionally, or alternatively, such a dam assembly 200 may be used to provide a seal around fittings in other water heater appliances (not shown) defining various other depths between their respective casings and tanks

Referring still to FIGS. 1 and 2, the water heater appliance 100 further includes a controller 134 that may be configured for regulating operation of water heater appliance 100. Controller 134 may be in operative communication with various components of the water heater appliances, including, for example, the heating elements 103, temperature sensors (not shown), and a control panel 107 (see FIG. 1). The control panel 107 may include various displays and input controls for user interface with the appliance 100. The controller 134 can, for example, selectively activate the heating elements 103 in order to heat water within the chamber 111 of the tank 101.

The controller 134 may include memory and one or more processing devices such as microprocessors, CPUs or the like, such as general or special purpose microprocessors operable to execute programming instructions or micro-control code associated with operation of the water heater appliance 100. The memory may represent random access memory such as DRAM, or read only memory such as ROM or FLASH. The processor may execute programming instructions stored in the memory. The memory may be a separate component from the processor or may be included onboard within the processor. Alternatively, the controller 134 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

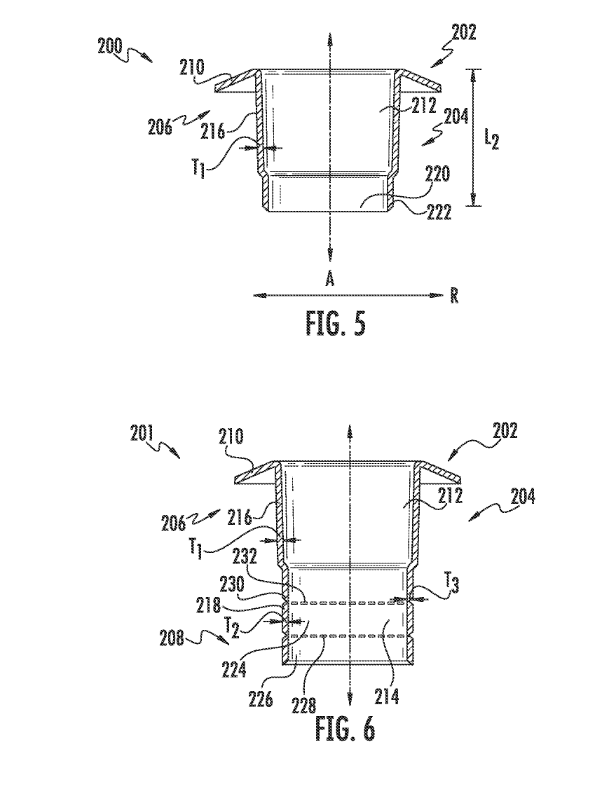

One exemplary embodiment of a dam assembly 200 will now be described with reference to FIGS. 3 through 5. FIG. 3 provides a perspective view of an exemplary dam assembly 200; FIG. 4 provides a cross-sectional view of the dam assembly 200 of FIG. 3 with a frangible section 214; and FIG. 5 provides a cross-sectional view of the dam assembly 200 of FIG. 3 with the frangible section 214 removed.

The dam assembly 200 generally defines an axial direction A, a circumferential direction C (FIG. 3), and a radial direction R. Additionally, the dam assembly 200 includes a cap 202 and a hollow extension 204. The hollow extension 204 extends along the axial direction A and defines a first end 206, a second end 208, and an effective length (generally referred to as “L” in FIG. 3). The cap 202 is attached to or integral with the hollow extension 204 proximate to the first end 206 of the hollow extension 204. More particularly, for the embodiment depicted, the cap 202 includes a flange 210 integral with the first end 206 of the hollow extension 204 and extending generally along the radial direction R outwardly from the first end 206. The cap 202 is configured for positioning adjacent to the casing 102 (see FIGS. 1-2) of the water heater appliance 100 to provide a seal around a respective opening in the casing 102.

The hollow extension 204 further includes a body portion 212 and a frangible section 214. The body portion 212 is positioned at the first end 206 of the hollow extension 204 and the frangible section 214 is positioned at the second end 208 of the hollow extension 204. The body portion 212 includes a wall 216 defining a first thickness T₁ in the radial direction R and, similarly, the frangible section 214 includes a wall 218 defining a second thickness T₂ in the radial direction R. For the embodiment depicted in FIGS. 3 through 5, the body portion 212 and the frangible section 214 each define a cylindrical shape. It should be appreciated, however, that in other exemplary embodiments, the body portion 212 and frangible section 214 may alternatively define any other suitable or desirable shape for positioning around one or more fittings in a water heater appliance 100. For example, the body portion and/or frangible section may alternatively define an ovular cross-sectional shape, rectangular cross-sectional shape, or any other suitable shape.

Referring still to FIGS. 3 through 5, the hollow extension 204 further includes a detachment band 220 extending along the axial direction A between the body portion 212 and the frangible section 214. The frangible section 214 is configured for removal from the body portion 212 along the detachment band 220. More particularly, the detachment band 220 also includes a wall 222 defining a third thickness T₃ in the radial direction R. The third thickness T₃ is less than the first thickness T₁ of the wall 216 of the body portion 212 and is also less than the second thickness T₂ of the wall 218 of the frangible section 214. Accordingly, for the embodiment depicted, a user may more easily rip, tear, and/or cut the frangible section 214 off or away from the body portion 212 along the detachment band 220 to reduce the effective length L of the hollow extension 204.

In certain exemplary embodiments, a ratio of the third thickness T₃ to the first thickness T₁ and/or the second thickness T₂ may be 3:4 or less, 1:2 or less, 1:4 or less, or 1:8 or less. It should be appreciated, however, that these exemplary ratios are by way of example only, and that in other exemplary embodiments of the present disclosure, the ratio of the third thickness T₃ to the first thickness T₁ and/or the second thickness T₂ may be greater than 3:4.

Referring particularly to FIG. 4, the dam assembly 200 is depicted with the frangible section 214 attached to the body portion 212 through the detachment band 220. In such an embodiment, the hollow extension 204 defines a first effective length L₁. Referring now to FIG. 5, the dam assembly 200 is depicted with the frangible section 214 removed from the body portion 212 along the detachment band 220. In such an embodiment, the hollow extension 204 defines a second effective length L₂ that is less than the first effective length L₁.

In certain embodiments of the present disclosure, the first effective length L₁ of the hollow extension 204 of the dam assembly 200 with the frangible section 214 (FIG. 4) may be greater than or equal to 2 inches. For example, the effective length L₁ may be greater than or equal to 2.25 inches, greater than or equal to 2.5 inches, or greater than or equal to 2.75 inches. Alternatively, however, in still other exemplary embodiments, the effective length L₁ may be less than 2 inches.

By contrast, the second effective length L₂ of the hollow extension 204 of the dam assembly 200 without the frangible section 214 (FIG. 5) may be less than 2 inches. For example, the effective length L₂ may be 1.75 inches or less, 1.65 inches or less, or 1.5 inches or less. Alternatively, however, in still other exemplary embodiments, the effective length L₂ may be greater than 2 inches.

The effective length L of the hollow extension 204 of the dam assembly 200 with and without the frangible section 214 may be selected such that the dam assembly 200 is adaptable to various depth requirements between the tank 101 and the casing 102 of the water heater appliance 100 (e.g., D₁ and D₂ depicted in FIGS. 1 and 2). Additionally, or alternatively, the effective length L of the hollow extension 204 of the dam assembly 200 with and without the frangible section 214 may be selected such that the dam assembly 200 is adaptable to various depth requirements between tanks and casings of various water heater appliances having difference sizes and, e.g., different insulation thickness requirements.

Referring still to FIGS. 3 through 5, in order to provide greater flexibility to the effective length L, the frangible section 214 may include two or more frangible members positioned along the axial direction A of the dam assembly 200. For example, in the exemplary embodiment of FIGS. 3 through 5, the frangible section 214 defines a first frangible member 224 and a second frangible member 226. The first frangible member 224 is attached to the body portion 212 through the detachment band 220 and the second frangible 226 member is attached to the first frangible 224 member through a second detachment band 228. For the embodiment depicted, the second detachment band 228 is configured in substantially the same manner as the primary detachment band 220.

The first and second frangible members 224, 226 each define a length L3 and L4, respectively. Moreover, for the embodiment depicted, the lengths L3 and L4 of the first and second frangible members 224, 226, respectively are approximately the same. As used herein, approximately refers to within a 10% margin of error.

It should be appreciated, however, that the exemplary dam assembly 200 provided in FIGS. 3 through 5 is by way of example only, and that in other exemplary embodiments, the dam assembly 200 may have any other suitable shape or configuration. For example, in other exemplary embodiments, the dam assembly 200 may not include the cap 202 positioned at the first end 206 of the hollow extension 204, or alternatively may include a cap 202 having any other suitable shape or configuration for providing a seal with the casing 102 of the appliance 100. Additionally, the cap 202 may not be made integrally with the hollow extension 204, and instead may be removably or permanently attached to the hollow extension 204. Moreover, in other exemplary embodiments, the frangible section 214 may include any suitable number of frangible members. For example, in other embodiments, the frangible section 214 may include a single frangible member, or alternatively may include three (3) or more frangible members spaced along the axial direction A, each connected to the adjacent frangible member by a detachable band.

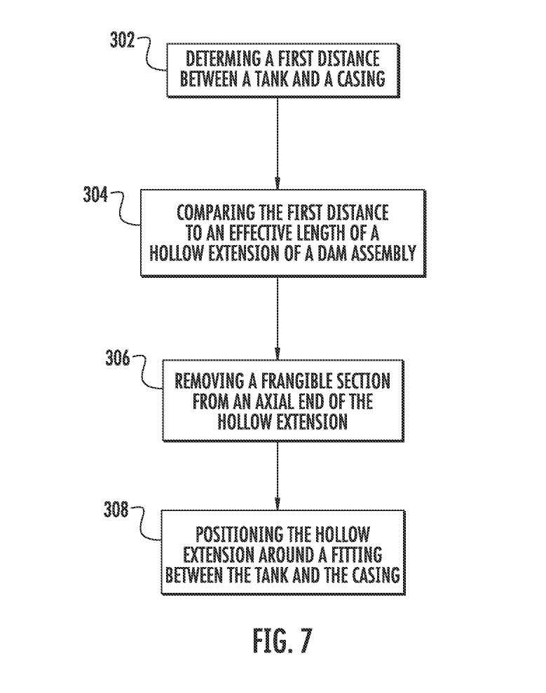

Referring now to FIG. 6, another exemplary embodiment of the dam assembly 200 with the frangible section 214 attached is provided. In the embodiment of FIG. 6, the detachment band 220 comprises a wall 230 defining a plurality of circumferentially spaced perforations 232. Moreover, the exemplary wall of FIG. 6 is depicted defining a third thickness T₃ that is less than the first thickness T₁ of the wall 216 of the body portion 212 and less than the second thickness T₂ of the wall 218 of the frangible section 214. The plurality of circumferentially spaced perforations 232 may be configured to assist a user in removing the frangible section 214 from the body portion 212 to reduce the effective length L of the hollow extension 204. Moreover, the size, shape, and spacing of the perforations 232 may be selected to provide for assisted removal of the frangible section 214 without allowing an unacceptable amount of, e.g., spray foam insulation therethrough.

It should be appreciated, however, that in still other exemplary embodiments the detachment band 220 may alternatively include any other suitable shape, size, and/or configuration for assisting a user in removal of the frangible section 214 from the body portion 212. For example, in other exemplary embodiments, the entirety of the hollow extension 204 may be made integrally, and the detachment band 220 may include a weakened portion of the hollow extension 204. Alternatively, in other embodiments, the body portion 212 of the hollow extension 204 may be made separately from the frangible section 214, and adjoined by the attachment band 220. In such an exemplary embodiment, the detachment band 220 may be comprised of a thinner and/or weaker material allowing for a user to more easily remove the frangible section 214. Alternatively, in still other exemplary embodiments, the detachment band 220 may comprise a layer of adhesive of other material configured to attach the frangible section 214 and body portion 212.

Referring now to FIG. 7, an exemplary flow chart is provided of a method (300) for manufacturing a water heater appliance including a tank with a casing positioned around at least a portion of the tank. In certain exemplary aspects, the method (300) may be used to manufacture the water heater appliance 100 depicted in FIGS. 1 and 2 and described above.

The exemplary method (300) includes at (302) determining a first distance between the casing and the tank proximate to a fitting extending from the tank through a respective hole in the casing. The step of determining at (302) may be completed by, e.g., measuring the distance or reading specifications of the water heater appliance. At (304), the method (300) additionally includes comparing the first distance to an effective length of a hollow extension of a dam assembly. In certain exemplary aspects, the dam assembly referred to in the exemplary method (300) described with reference to FIG. 7 may include one or more features of the dam assemblies 200 described above with reference to FIGS. 3 through 5 and/or FIG. 6.

Referring still to FIG. 7, the exemplary method (300) includes at (306) removing a frangible section from an axial end of the hollow extension along an axially extending detachment band. By removing the frangible section from the axial end of the hollow extension, the effective length of the hollow extension is approximately equal to the first distance determined at (302). As used herein, “approximately” refers to within a 10% margin of error.

In certain exemplary aspects, removing the frangible section from the axial end of the hollow extension at (306) may include tearing the hollow extension along the detachment band. More particularly, in still other exemplary aspects, tearing the hollow extension along the detachment band may include tearing the hollow extension along a plurality of circumferentially spaced perforations defined in the detachment band. However, in other exemplary aspects, any other method may be utilized for removing the frangible section from the axial end of the hollow extension at (306).

Once the frangible section is removed at (306), the method (300) includes positioning the dam assembly around the fitting between the tank and the casing at (308). In other exemplary aspects, the step of positioning the dam assembly around the fitting between the tank and the casing at (308) may include providing a seal between the tank and the casing around the fitting. Such an embodiment may allow for the providing of insulation material between the outer casing and the tank after said step of positioning the dam assembly around the fitting between the tank and the casing.

In another exemplary aspect of the method (300) of FIG. 7, the method (300) may further include determining a second distance between a second casing and a second tank of a second water heater appliance. The second distance may be proximate to a second fitting extending from the second tank through a respective opening in the second casing. Such an exemplary aspect may further include positioning a second dam assembly around the second fitting with the second distance being approximately equal to an effective length of a hollow extension of the second dam assembly. The hollow extension of the second dam assembly may include frangible section positioned at an axial end of the hollow extension of the second dam assembly. Moreover, in such an exemplary aspect, the second distance determined may be different than the first distance determined at (302).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal language of the claims.

What is claimed:

1. A dam assembly defining an axial direction for positioning around a fitting in a water heater, the dam assembly comprising:
a hollow extension extending along the axial direction and defining a first end, a second end, and an effective length, the hollow extension comprising
a body portion positioned at the first end;
a frangible section positioned at the second end; and
a detachment band extending along the axial direction between the body portion and the frangible section, the frangible section configured for removal from the body portion along the detachment band, wherein removal of the frangible section from the body portion reduces the effective length of the hollow extension.

2. The dam assembly of claim 1, wherein the body portion and the frangible section each define a cylindrical shape.

3. The dam assembly of claim 1, wherein the body portion comprises a wall defining a first thickness in a radial direction, wherein the frangible section comprises a wall defining a second thickness in the radial direction, and wherein the detachment band comprises a wall defining a third thickness in the radial direction, the third thickness being less than the first thickness and less than the second thickness.

4. The dam assembly of claim 1, wherein the dam assembly further defines a circumferential direction, and wherein the detachment band comprises a wall defining a plurality of perforations spaced along the circumferential direction.

5. The dam assembly of claim 1, further comprising a cap attached to or integral with the hollow extension proximate to the first end of the hollow extension.

6. The dam assembly of claim 5, wherein the cap comprises a flange extending along a radial direction outwardly from the first end of the extension, the flange configured for positioning adjacent to a casing of the water heater.

7. The dam assembly of claim 1, wherein the effective length of the hollow extension with the frangible section is greater than or equal to 2 inches, and wherein the effective length of the hollow extension without the frangible section is less than 2 inches and greater than or equal to about 1 inch.

8. The dam assembly of claim 1, wherein the frangible section comprises two or more frangible members positioned along the axial direction.

9. The dam assembly of claim 8, wherein each frangible member defines a length along the axial direction, and wherein the length of each frangible member along the axial direction is approximately the same.

10. A method of manufacturing a water heater including a tank with a casing positioned around at least a portion of the tank, the method comprising
determining a first distance between the casing and the tank proximate to a fitting extending from the tank through a respective hole in the casing;
comparing the first distance to an effective length of a hollow extension of a dam assembly;
removing a frangible section from an axial end of the hollow extension along an axially extending detachment band such that the effective length of the hollow extension is approximately equal to the first distance; and
positioning the dam assembly around the fitting between the tank and the casing.

11. The method of claim 10, wherein said step of removing the frangible section from the axial end of the hollow extension comprises tearing the hollow extension along the detachment band.

12. The method of claim 11, wherein said step of tearing the hollow extension along the detachment band comprises tearing the hollow extension along a plurality of circumferentially spaced perforations defined in the detachment band.

13. The method of claim 10, wherein said step of positioning the dam assembly around the fitting between the tank and the casing comprises providing a seal between the tank the casing around the fitting.

14. The method of claim 10, further comprising
providing insulation material between the outer casing and the tank after said step of positioning the dam assembly around the fitting between the tank and the casing.

15. The method of claim 10, wherein the hollow extension of the dam assembly defines a first end and a second end, and comprises a body portion positioned at the first end and the frangible section positioned at the second end, the detachment band extending axially between the body portion and the frangible section.

16. The method of claim 10, further comprising
determining a second distance between a second casing and a second tank proximate to a second fitting extending from the second tank through a respective opening in the second casing;
positioning a second dam assembly around the second fitting, the second distance approximately equal to an effective length of a hollow extension of the second dam assembly, the hollow extension of the second dam assembly including a frangible section positioned at an axial end of the hollow extension of the second dam assembly.

17. A water heater comprising:
a tank for holding a quantity of water;
a casing positioned around at least a portion of the tank;
a fitting extending from the tank through a respective opening in the casing; and
a dam assembly comprising a hollow extension positioned around the fitting between the tank and the casing, the dam assembly defining an axial direction with the hollow extension extending along the axial direction and comprising
a body portion positioned at a first end of the hollow extension;
a frangible section positioned at a second end of the hollow extension; and
a detachment band extending along the axial direction between the body portion and the frangible section, the frangible section configured for removal from the body portion along the detachment band to reduce an effective length of the hollow extension.

18. The water heater of claim 16, wherein the body portion comprises a wall defining a first thickness in a radial direction, wherein the frangible section comprises a wall defining a second thickness in the radial direction, and wherein the detachment band comprises a wall defining a third thickness in the radial direction, the third thickness being less than the first thickness and less than the second thickness.

19. The water heater of claim 16, wherein the dam assembly further defines a circumferential direction, and wherein the detachment band comprises a wall defining a plurality of perforations spaced along the circumferential direction.

20. The water heater of claim 16, wherein the water heater defines a first distance between the casing and the tank, and wherein the first distance is approximately equal to the effective length of the hollow extension.
